(19) United States
(12) Patent Application Publication
(10) Pub. No.: US 2015/0274562 A1
(43) Pub. Date: Oct. 1, 2015

(54) Wastewater Refinery

(71) Applicants: GRAINS RESEARCH & DEVELOPMENT CORPORATION, Barton (AU); THE UNIVERSITY OF QUEENSLAND, St Lucia (AU)

(72) Inventors: Damien Batstone, St Lucia (AU); Chirag Mehta, St Lucia (AU)

(73) Assignees: Grains Research & Development Corporation, Barton (AU); The University of Queensland, St Lucia (AU)

(21) Appl. No.: 14/433,942

(22) PCT Filed: Oct. 14, 2013
(86) PCT No.: PCT/AU2013/001188

§ 371 Date: Apr. 7, 2015

(30) Foreign Application Priority Data
Oct. 12, 2012 (AU) 2012904469

(51) Int. Cl. C02F 9/00; B01D 61/48; C02F 1/52; B01D 61/58; C02F 1/469; C02F 1/44; B01D 61/44; B01D 61/36

(52) U.S. Cl. CPC C02F 9/00; B01D 61/44; B01D 61/445; B01D 61/48; B01D 61/362; B01D 61/58; C02F 1/4695; C02F 1/448; C02F 1/52; B01D 2311/2642; B01D 2311/2653; C02F 2101/16

(57) ABSTRACT

A wastewater refinery comprising one or more electrodialytic cells with mono-, di-, or multi-valent selective membranes interspersed with one or more concentrate compartments to selectively recovery ions from wastewater. The wastewater refinery may harvest ions by utilising techniques including ion selective resins and pervaporation. The refinery finds particular application for recovery of potassium, phosphate and ammonium:

### FIELD OF THE INVENTION

The present invention relates to beneficiation of wastewater streams. In particular, the invention relates to a wastewater refinery including an electrodialysis cell for recovering and/or removing components of wastewater streams.

### BACKGROUND TO THE INVENTION

Beneficiation of wastewater streams is highly desirable, both for recovery of valuable components of the streams, and for removal of undesirable components and regeneration of usable water.

Wastewater is generally understood to be any water that has been adversely affected in quality by anthropogenic influence, including liquid waste discharged by domestic residences, commercial properties, industry, and/or agriculture, and can encompass a wide range of potential contaminants and concentrations.

Electrodialysis is a technique used to transport salt ions from one solution through ion-exchange membranes to another solution under the influence of an applied electric potential difference. This is done in a configuration called an electrodialysis cell. The cell consists of a three compartment configuration, with anode, central, and cathode compartments, and with individual compartments separated by anion exchange membranes (AEMs) or cation exchange membranes (CEMs). In almost all practical electrodialysis processes, multiple electrodialysis cells are arranged into a configuration called an electrodialysis stack, with alternating anion and cation exchange membranes forming the multiple electrodialysis cells.

In an electrodialysis stack, the diluate (D) feed stream, concentrate (C) stream, and electrode (E) stream are allowed to flow through the appropriate cell compartments formed by the ion exchange membranes. Under the influence of an electrical potential difference, the negatively charged ions (e.g., chloride) in the diluate stream migrate toward the positively charged anode. These ions pass through the positively charged anion exchange membrane, but are prevented from further migration toward the anode by the negatively charged cation exchange membrane and therefore stay in the C stream, which becomes concentrated with the anions. The positively charged species (e.g., sodium) in the D stream migrate toward the negatively charged cathode and pass through the negatively charged cation exchange membrane. These cations also stay in the C stream, prevented from further migration toward the cathode by the positively charged anion exchange membrane. As a result of the anion and cation migration, electric current flows between the cathode and anode. An equal number of anion and cation charge equivalents are transferred from the D stream into the C stream and so the charge balance is maintained in each stream. The overall result of the electrodialysis process is an ion concentration increase in the concentrate stream with a depletion of ions in the diluate solution feed stream.

The E stream is the electrode stream that flows past each electrode in the stack. This stream may consist of the same composition as the feed stream or may be a separate solution containing a different species. Depending on the stack configuration, anions and cations from the electrode stream may be transported into the C stream, or anions and cations from the D stream may be transported into the E stream. In each case, this transport is necessary to carry current across the stack. An increase in ion transport due to decreased diffusivity or other resistance to transport will result in a decrease in current, or increase in voltage for an equivalent total current.

Some particular examples are published on the use of electrodialysis for the recovery of nitrogen, a valuable component from a specific waste stream. For example, the recovery of ammonia from swine manure using electrodialysis in combination with other techniques is described in Ippersiel D, Mondor M, Lamarche F, Tremblay F, Dubreuil J, Masse L. 2011, Nitrogen potential recovery and concentration of ammonia from swine manure using electrodialysis coupled with air stripping. Journal of Environmental Management; Mondor M, Ippersiel D, Lamarche F, Masse L. 2009, Fouling characterization of electrodialysis membranes used for the recovery and concentration of ammonia from swine manure, Bioresource Technology 100(2):566-571; and Mondor M, Masse L, Ippersiel D, Lamarche F, Massé DI. 2008, Use of electrodialysis and reverse osmosis for the recovery and concentration of ammonia from swine manure, Bioresource Technology 99(15):7363-7368.

In addition, use of electrodialysis technology is described for removal of micropollutants from a urine wastestream, to give a concentrated salt stream in Pronk W, Biebow M, Boller M. 2006, Electrodialysis for Recovering Salts from a Urine Solution Containing Micropollutants, Environmental Science & Technology 40(7):2414-2420 and concentrated nutrients stream in Pronk W, Zuleeg S, Lienert J, Escher B, Koller M, Berner A, Koch G, Boller M. 2007. Pilot experiments with electrodialysis and ozonation for the production of a fertiliser from urine, Water Science & Technology 56(5):219-227.

These investigations used permselective anion and/or cation exchange membranes in the electrodialysis cell with the membrane being non-selective towards the valency of ions being transported. The applications are for recovery of single components or single valency components (mainly ammonia), or removal of unwanted components to recycle the water. None of these applications considered the use of selective removal due to phase transport, and reported difficulties in maintaining the pH of the C stream due to non-selective ion transport.

### SUMMARY OF THE INVENTION

According to one aspect, the invention resides in a wastewater refinery comprising an electrodialytic cell, wherein the electrodialytic cell comprises mono-, di- or multi-valent selective membranes interspersed with one or more concentrate compartment.

According to a second aspect, the invention resides in a wastewater refinery comprising an electrodialytic cell, wherein the electrodialytic cell comprises mono-, di- or multi-valent membranes interspersed with one or more concentrate compartments, wherein at least one of the concentrate compartments is adapted to selectively substantially exclude a component from the concentrate.

The wastewater suitable for use in the refinery of the invention can be any wastewater, including industrial, agricultural and domestic wastewater.

The refinery of the invention can be configured to recover any component from the wastewater, but economically will be dictated by the sale value of the component. For example, components considered high value at the time of making the invention include potassium, ammonium, and phosphate. The refinery of the invention can therefore be configured to recover components from anion or cation recovery.

The electrodialytic cell of the invention may comprise any ion-selective membranes, including cation selective membranes and anion selective membranes, and membranes selective for different and/or specific valencies, for example divalent or trivalent cation selective membranes and divalent or trivalent anion selective membranes. The membranes can also be bipolar membranes which can control pH within a compartment to improve recovery of a specific ion.

The electrodialytic cell of the invention may include more than one ion/valency selective membrane and/or more than one concentrate compartment. The plurality of membranes and concentrate compartments can be in series between the anode and cathode of the electrodialytic cell.

The electrodialytic cell can be configured in the order from anode to cathode as follows: the anode adjacent to a repeating configuration of cation selective membrane, concentrate compartment, anion selective membrane, diluate compartment, to an anion selective membrane adjacent to the cathode. An example of cell configuration would be represented as follows: anode-E/CEM/C/AEM/D/CEM/C/AEM/D/CEM/C/AEM/E-cathode.

In a third aspect of the invention, there is provided a method of concentrating one or more component of wastewater, the method comprising the steps of:

introducing the wastewater into an electrodialysis cell;

providing one or more ion valency selective membrane in the cell, specific for the one or more component;

generating a current in the cell such that the one or more component moves through the membrane/s according to charge;

concentrating the one of more component in respective concentrate compartment; and

recovering the one or more component from the compartment.

In the second and third aspects of the invention, at least one of the concentrate compartments is adapted to selectively retain and hence substantially remove a component from the concentrate. The adaption of the concentrate compartment can be any adaptation which effectively removes a single component from the wastewater. For example the adaptation can comprise packing with ion exchange resin, ion capture resin, or gas permeable membranes and pervaporation membranes.

The adaption in the concentrate compartment can be used to recover a desired component, or to remove an undesired component.

Further features and advantages of the present invention will become apparent from the following detailed description.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1 represents a wastewater refinery according to a first embodiment of the invention;

FIG. 2 represents a wastewater refinery according to a second embodiment of the invention;

FIG. 3 represents a wastewater refinery according to a third embodiment of the invention;

FIG. 4 represents a wastewater refinery according to a fourth embodiment of the invention; and

FIG. 5 represents a wastewater refinery according to a fifth embodiment of the invention.

Those skilled in the art will appreciate that minor deviations from the layout of components as illustrated in the drawings will not detract from the proper functioning of the disclosed embodiments of the present invention.

### DETAILED DESCRIPTION OF THE INVENTION

Embodiments of the present invention comprise a wastewater refinery. Elements of the invention are illustrated in concise outline form in the drawings, showing only those specific details that are necessary to the understanding of the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

The reference to any prior art in this specification is not, and should not be taken as, an acknowledgement or any form of suggestion that the prior art forms part of the common general knowledge.

The wastewater refinery of the invention can be used for recovery and/or removal of most components of many wastewater streams. Some examples of wastewater streams appropriate for use in the refinery of the invention include agricultural wastewater streams, domestic wastewater streams, and industrial wastewater streams such as thin stillage and dunder. The wastewater stream can be filtered before feeding into the electrodialytic cell, if required, and depending on the level of solid contaminants in the stream.

Wastewater streams can include any number of anions and/or cations which may be desirable for removal and/or recovery from the stream. Examples of these include, but are not limited to potassium, ammonia, phosphate, sodium, iron, chlorine, sulphate, chromium and silver.

Permselective AEMs and CEMs appropriate for use in the invention includes commercially available multivalent and monovalent membranes from Membrane International, USA; Ameridia, Tokuyama Corporation, Japan; and Selemion, HCF, Asahi, Japan.

### EXAMPLE 1

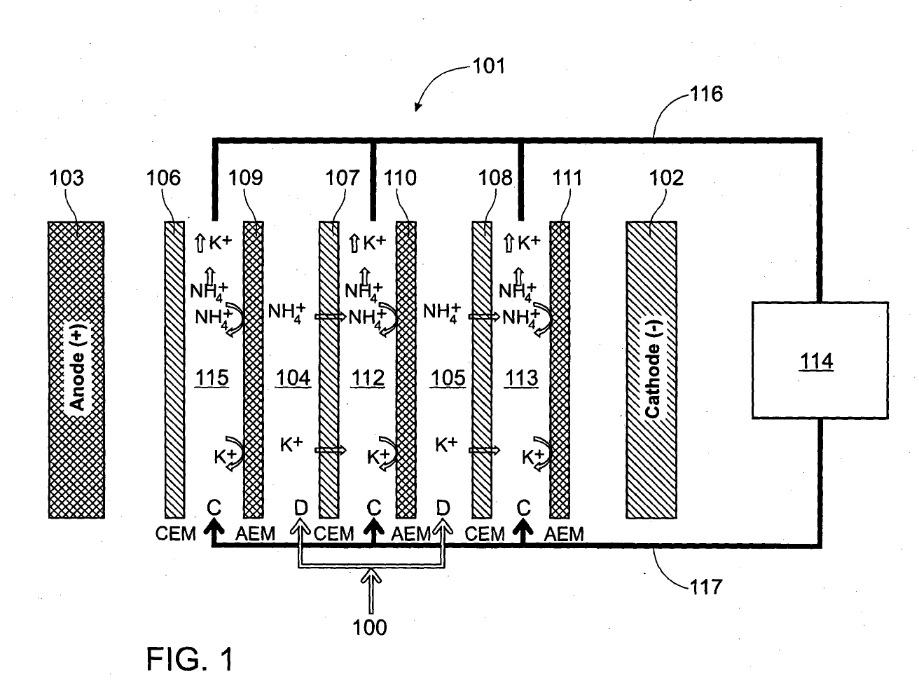

Referring to FIG. 1, in this simple example of the use of a wastewater refinery of the invention, the recovery of potassium (K⁺) and ammonium (NH₄⁺) is represented, from wastewater (100) which includes at least K⁺ and NH₄.

Wastewater (100) is introduced into the electrodialysis cell (101) of the invention, which includes a cathode (102) at a first end and an anode (103) at the opposing end. The cathode is preferably 316 stainless steel and the anode is preferably mixed metal oxide, but may include alternatives that operate at a lower potential. The flow rate of the wastewater can be any suitable flowrate and is not limiting, given proper design of the cell. The cell suitably operates at ambient temperature.

A potential is applied to the cell (101) and wastewater (100) is introduced into compartments (104,105) between the cathode (102) and anode (103). The potential applied is preferably about 0.1-3 V per compartment. In this example of the invention, anions in the wastewater move by diffusion towards the anode (103), while the cations, K⁺ and NH₄⁺, diffuse towards the cathode (102).

During this diffusion, the cations pass through cation exchange membranes (107, 108), but are rejected from anion exchange membranes (109, 110, 111). Persons skilled in the field will understand that it is meant that the ion exchange membranes will preferential pass or reject selected ions. This results in a concentration of cations in compartments (112, 113). The concentrate from these compartments are in fluid communication via line (116) to concentrate reservoir (114) and can then be fed back into the cell (101) at compartments (112, 113, 115) via line (117) until the concentration of cations warrants removal and recovery. Removal and recovery may be by any suitable method such as precipitation from the concentration reservoir (114) or with ion capture resins.

Although not specifically shown in this example it will be appreciated that the anions will pass through anion exchange membranes (109, 110) but will be rejected by cation exchange membranes (106, 107, 108).

### EXAMPLE 2

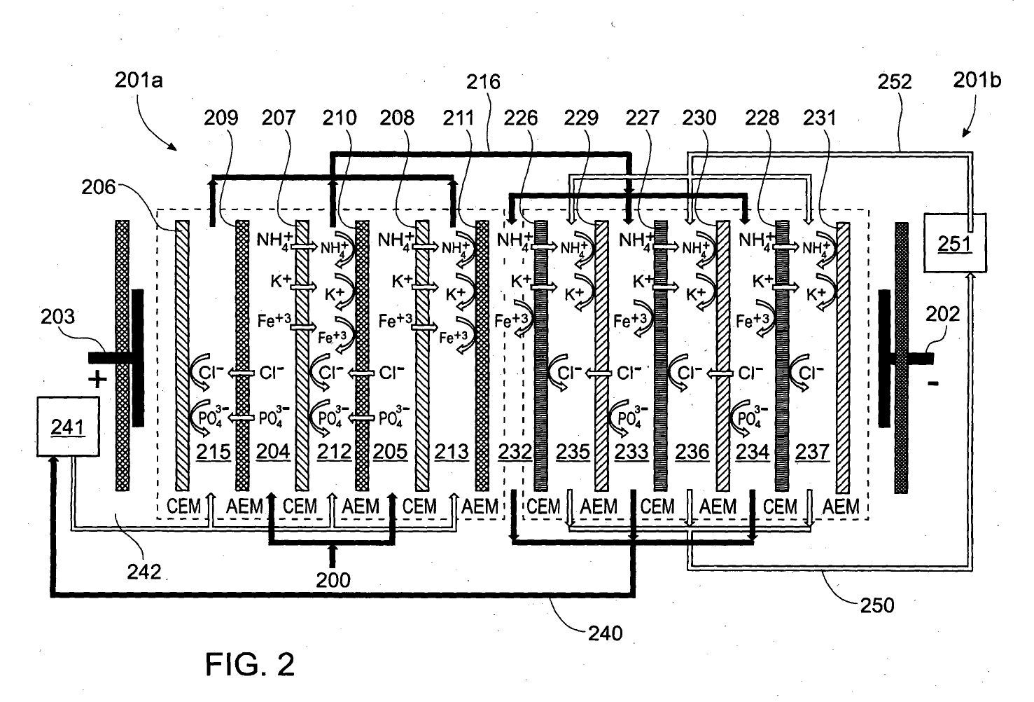

Referring to FIG. 2, a more complex example of the invention can be envisaged, being the recovery of potassium (K⁺), ammonia (NH₄⁺) and phosphate (PO₄³⁻) from wastewater (200) which includes cations K⁺, Fe³⁺, NH₄⁺ and anions PO₄³⁻ and Cl⁻. This example includes two electrodialytic cells (201a, 201b) operated in series. The first cell includes permselective membranes and the second cell includes valent selective membranes.

Wastewater (200) is introduced into the electrodialysis cell of the invention, which includes a cathode (202) at a first end and an anode (203) at the opposing end as previously described.

A current is applied to the cell and the wastewater (200) is introduced into compartments (204, 205) between the cathode (202) and anode (203). In this example of the invention, the anions in the wastewater, PO₄³⁻ and Cl⁻, move by diffusion towards the anode (203), while the cations, K⁺, Fe³⁺, and NH₄⁺, diffuse towards the cathode (202). The anions diffuse through a set of anion selective membranes (209, 210) to concentrate in concentrate compartments (212, 215) from where they are fed via feed line (216) to the second cell (201b) containing a set of monovalent anion exchange membranes (229, 230, 231).

Similarly, the cations diffuse through a set of cation selective membranes (207, 208) to concentrate in concentrate compartments (212, 213) from where they are fed via line (216) to the second cell (201b) containing a set of monovalent cation exchange membranes (226, 227, 228).

Cation exchange membrane (206) and anion exchange membrane (211) complete the first cell (201a). The cation exchange membrane (206) concentrates anions in compartment (215) and the anion exchange membrane (211) concentrates cations in compartment (213).

The feed line (216) contains a concentrate stream of anions and cations, which in this example includes K⁺, Fe³⁺, NH₄⁺, Cl⁻ and PO₄³⁻.

Monovalent anions from the concentrate stream diffuse through the monovalent selective membranes (229, 230) which permit diffusion of the monovalent Cl⁻ ions, but not the trivalent PO₄³⁻ ions. This effectively separates the PO₄³⁻ anions from the Cl⁻ anions.

Concurrently, monovalent cations from the concentrate stream diffuse through the monovalent selective membranes (227, 228) which permit diffusion of the monovalent K⁺ and NH₄⁺ ions, but not the trivalent Fe³⁺ ions. This effectively separates the Fe³⁺ cations from the K⁺ and NH₄⁺ cations.

The compartments (232, 233, 234) have a high concentration of trivalent ions which are fed via feed line (240) to first concentrate reservoir (241). The ions with high value, such as PO₄³⁻, can be recovered by precipitation or other appropriate means. The concentrate from concentrate reservoir (241) can be recycled to compartments (212, 213, 215) in the first cell (201a) through feed line (242).

The compartments (235, 236, 237) have a high concentration of monovalent ions which are fed via feed line (250) to second concentrate reservoir (251). The ions with high value can be recovered by precipitation or other appropriate means. The concentrate from concentrate reservoir (251) can be recycled to compartments (235, 236, 237) in the second cell (201b) through feed line (252).

It will be appreciated that the cells (201a, 201b) of Example 2 could be operated as independent cells in the manner of FIG. 1. However, operating as effectively a single cell leverages increased conductivity in the internal concentrate recycling and assists to reduce pH gradients.

### EXAMPLE 2A

This example is an extension of Example 2, where monovalent ions can be selectively separated. The first cell includes permselective membranes and the second cell includes surface-modified monovalent membranes. The process is as described above for Example 2 but surface-modified monovalent membranes are used instead of the valent selective membranes of Example 2 to reject specific monovalent ions.

In this example of the invention, the cations in the wastewater, K⁺, Fe³⁺, and NH₄⁺, diffuse towards the cathode. The ions in the wastewater reach a first cation selective membrane and the cations diffuse through this membrane to concentrate in a first cation concentrate compartment. This concentrate continues to diffuse towards the cathode, and reaches a chemical-modified monovalent exchange membrane. The membrane surface is chemically modified to reject NH₄⁺. Monovalent cations such as K⁺ diffuse through this membrane into a second cation concentrate compartment, and NH₄⁺ and Fe³⁺ remain in the first cation concentrate compartment.

It will be appreciated that by appropriate selection of surface-modified monovalent membranes any specific ion can be selected.

The concentrate streams from the first and second concentrate compartments described above can also be returned to the respective electrodialysis cell inlet, and recycled for further concentration. High value ions maybe precipitated from the concentrate reservoir.

### EXAMPLE 3

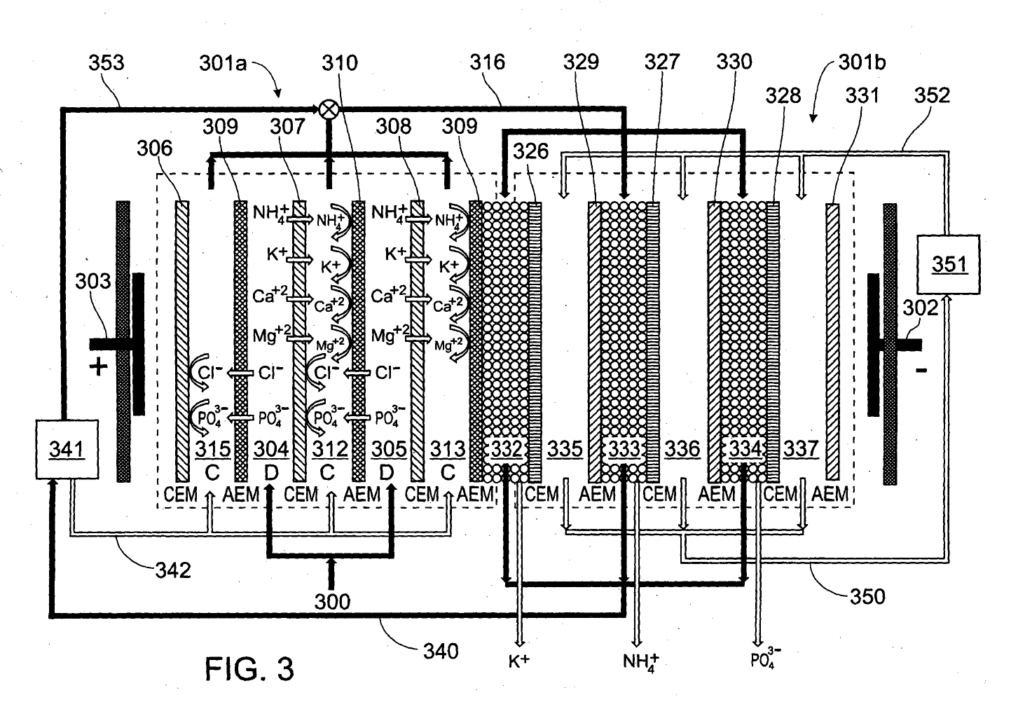

Referring to FIG. 3, this example is an extension of Example 2 described above. Wastewater (300) is introduced into the electrodialysis cells (301a, 301b) of the invention, which includes a cathode (302) at a first end and an anode (303) at the opposing end as previously described.

A current is applied to the cell and the wastewater (300) is introduced into compartments (304) and (305) between the cathode (302) and anode (303). In this example it is considered that the wastewater (300) also contains Ca²⁺, Mg²⁺ and Na⁺ but not Fe³⁺. As with Example 2, the anions in the wastewater, PO₄³⁻ and Cl⁻, move by diffusion towards the anode (303), while the cations Ca²⁺, Mg²⁺, K⁺, and NH₄⁺, diffuse towards the cathode (302). The anions diffuse through a set of anion selective membranes (309, 310) to concentrate in concentrate compartments (312, 315) from where they are fed via feed line (316) to the second cell (301b) containing a set of monovalent anion exchange membranes (329, 330, 331).

Similarly, the cations diffuse through a set of cation selective membranes (307, 308) to concentrate in concentrate compartments (312, 313) from where they are fed via line (316) to the second cell (301b) containing a set of monovalent cation exchange membranes (326, 327, 328).

Cation exchange membrane (306) and anion exchange membrane (311) complete the first cell (301a). The cation exchange membrane (306) concentrates anions in compartment (315) and the anion exchange membrane (311) concentrates cations in compartment (313).

The feed line (316) contains a concentrate stream of anions and cations, which in this example includes Ca²⁺, Mg²⁺, Na⁺, K⁺, Cl⁻ and PO₄³⁻. The feed line (316) delivers the concentrate stream to compartments (332, 333, 334) which are packed with ion exchange media such as the cation exchange resin, clinoptilolite, that preferentially absorbs K⁺. Each compartment may contain the same resin to maximise recovery of one ion. However, the invention is more efficacious if each compartment (332, 333, 334) is packed with a different ion exchange media. By way of example, a first cation exchange resin may be packed in compartment (332) for recovering K⁺, a second cation exchange resin may be packed in compartment (333) for recovering NH₄⁺, and a first anion exchange resin may be packed in compartment (334) for recovering PO₄³⁻. Each of these ions may be recovered into separate lines according to the appropriate method for the particular ion exchange medium, such as periodic washing.

Unrecovered monovalent anions from the concentrate stream diffuse through the monovalent selective membranes (329, 330) which permit diffusion of the monovalent C⁻ ions, but not the trivalent PO₄³⁻ ions. This effectively separates the PO₄³⁻ anions from the Cl⁻ anions.

Concurrently, unrecovered monovalent cations from the concentrate stream diffuse through the monovalent selective membranes (327, 328) which permit diffusion of the monovalent K⁺ and NH₄⁺ ions, but not the divalent Ca²⁺ and Mg²⁺ ions. This effectively separates the Ca²⁺ and Mg²⁺ cations from the K⁺ and NH₄⁺ cations.

The compartments (332, 333, 334) have a high concentration of divalent ions (the trivalent PO₄³⁻ having been recovered by the resin) which are fed via feed line (340) to first concentrate reservoir (341). The concentrate from concentrate reservoir (341) can be recycled to compartments (312, 313, 315) in the first cell (301a) through feed line (342) or to compartments (335, 336, 337) in second cell (301b). This allows for control of product quality and operating conditions by directing concentrate from the first concentrate reservoir (341) into the first cell (301a) or second cell (301b) as required.

The compartments (335, 336, 337) have a high concentration of monovalent ions (other than K⁺ and NH₄⁺ ions) which are fed via feed line (350) to second concentrate reservoir (351). The ions with high value can be recovered by precipitation or other appropriate means. The concentrate from concentrate reservoir (351) can be recycled to compartments (335, 336, 337) in the second cell (301b) through feed line (352).

The embodiment could operate with or without the second concentrate reservoir (351).

### EXAMPLE 4

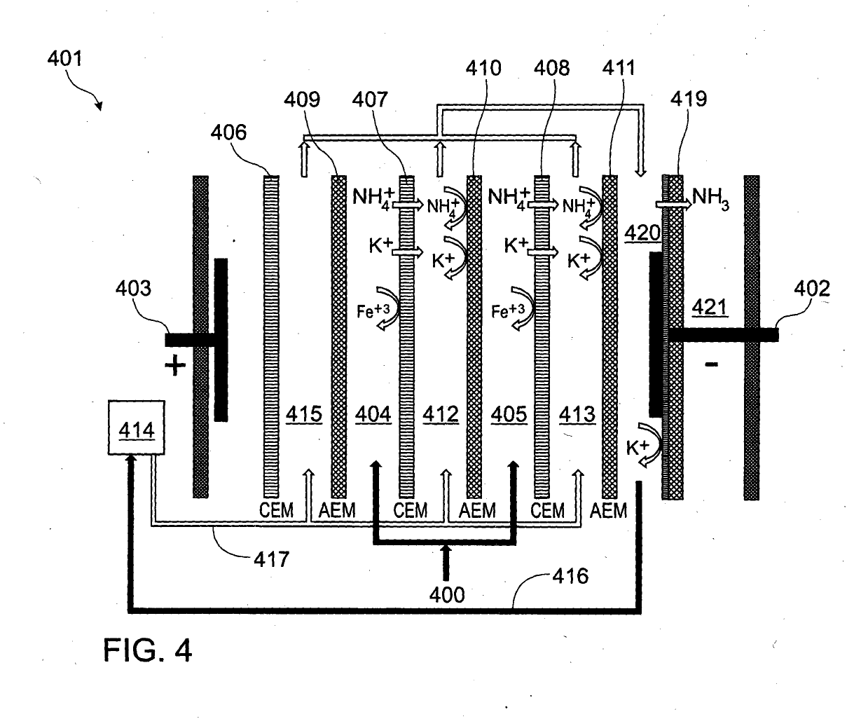

Referring to FIG. 4, this example is an extension of Example 1 described above. Wastewater (400) is introduced into the electrodialysis cell (401) of the invention, which includes a cathode (402) at a first end and an anode (403) at the opposing end. A potential is applied to the cell (401) and wastewater (400) is introduced into compartments (404, 405) between the cathode (402) and anode (403).

In this example monovalent membranes are used instead of the permselective membranes to remove monovalent ions. Once the ions diffuse through the monovalent membrane (CEMs for cations and AEMs for anions) specific ions are selectively recovered from compartment (420) into compartment (421) using gas permeable membrane (419) at the cathode (402). A vacuum in compartment (421) draws volatile components, such as NH₃, through the gas permeable membrane (419) for recovery.

In this example of the invention, the cations in the wastewater, K⁺, Fe³⁺, and NH₄⁺, diffuse towards the cathode (402). The ions in the wastewater reach a monovalent cation selective membrane (407, 408) and the monovalent cations diffuse through this membrane to concentrate in concentrate compartment (412) (413). The concentrate from compartments (412, 413, 415) are delivered through feed line (418) to pervaporation compartment (420). As the NH₄⁺ approaches the cathode (402) there is a localised rise in pH (pH>9.0) which causes the NH₄⁺ to convert to the more volatile NH₃. The NH₃ diffuses into the gas capture compartment (421) and is recovered by, for example, acid trap or low vacuum.

The concentrate steam containing K⁺may be returned to the electrolysis cell via concentrate reservoir (414) or may be harvested from the concentrate reservoir (414).

### EXAMPLE 5

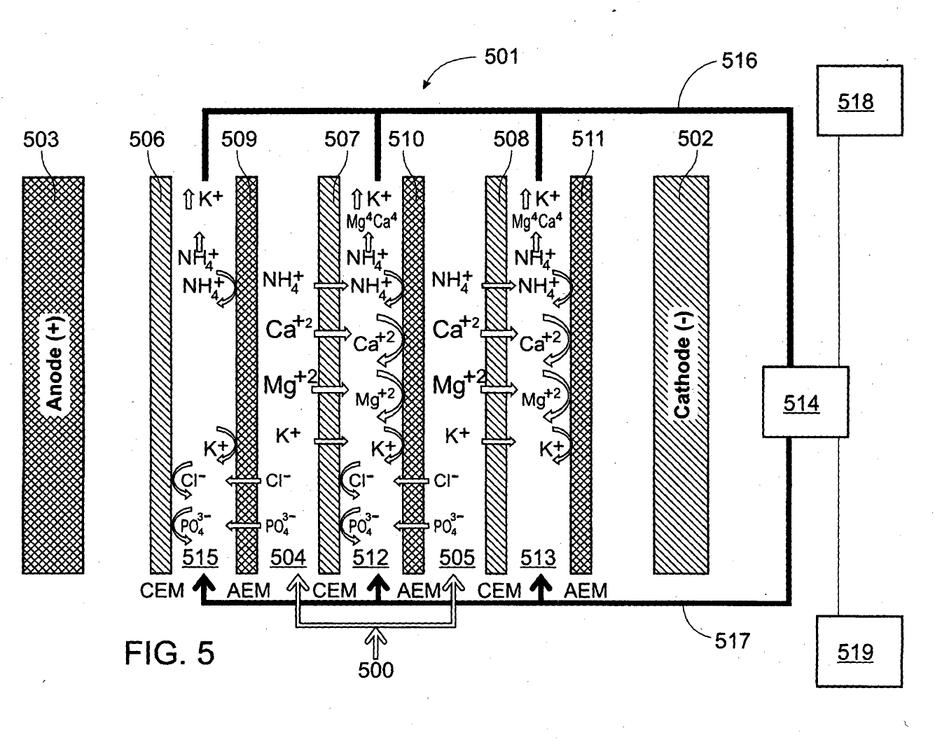

Referring to FIG. 5, this example is an extension of example 1. Once the ions diffuse through permselective membrane, i.e. CEMs for cations and AEMs for anions, specific ions are selectively precipitated and removed from the concentrate stream.

In this example of the invention, the cations in the wastewater (500), K⁺, Ca², Mg²⁺ and NH₄⁺, diffuse towards the cathode (502) and the anions, PO₄³⁻ and Cl², diffuse towards the anode (503). The cations in the wastewater reach a cation selective membrane (507, 508) and the cations diffuse through this membrane to concentrate in a concentrate compartment (512, 513). Similarly, the anions in the wastewater reach an anion selective membrane (509, 510) and the anions diffuse through this membrane to concentrate in a concentrate compartment (512, 515). The concentrate in compartments (512, 513, 515) are fed through feed line (516) to concentrate reservoir (514).

In this example, counter ions (anions) are added to the concentrate reservoir, i.e. CO₂ and water from tank (518) is added to precipitate CaCO₃ and MgCO₃ in the concentrate reservoir which is collected in a storage tank (519). The process of adding counter ions to precipitate specific compounds may be combined with in-reactor manipulation of pH by bipolar membranes, electrochemical or chemical techniques to achieve more optimal operation or enhance recovery. In practice, in-reactor manipulation of pH by electrochemical or chemical or by bipolar membranes can be used to correct pH and reduce precipitation, as precipitation is a major concern for the electrodialysis process. The process of adding counter ions to precipitate specific compounds usually occurs outside the electrodialysis unit. The precipitation process can drift the pH of the concentrate. This drift can be corrected by using in-reactor pH manipulation techniques as mentioned above.

The concentrate streams containing K⁴ and NH₄⁺ from the concentrate reservoir (514) can also be returned to the electrodialysis cell inlet through feed line (517), and recycled for further concentration.

In addition, the order, nature and number of membranes and associated compartments can be varied according to the desired outcome of the process. In this way, many valuable components of wastewater streams can be recovered, or undesirable components removed. It will also be appreciated that various techniques, some of which have been mentioned above, can be used to harvest ions from the concentration reservoirs of each embodiment. Furthermore, each embodiment focuses on recovery of one or two ions but it will be appreciated that techniques from different embodiments may be combined for recovery of multiple ions from the refinery.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this invention is intended to embrace all alternatives, modifications and variations of the present invention that have been discussed herein, and other embodiments that fall within the spirit and scope of the above described invention.

1. A wastewater refinery for concentrating one or more components of wastewater, the wastewater refinery comprising at least one electrodialytic cell, wherein the at least one electrodialytic cell comprises a plurality of membranes and a plurality of concentrate compartments, each concentrate compartment being defined between an adjacent pair of membranes, and wherein the plurality of membranes comprise a combination of ion-specific or valency-specific or surface-modified ion-exchange membranes.

2. The wastewater refinery of claim 1, wherein at least one of the concentrate compartments selectively substantially excludes a component from a concentrate of the at least one concentrate compartment.

3. The wastewater refinery of claim 1, wherein at least one of the concentrate compartments selectively substantially retains a component from a concentrate of the at least one concentrate compartment.

4. The wastewater refinery of claim 1, when configured to recover one or more of the following components: potassium, ammonium, and phosphate from the wastewater.

5. The wastewater refinery of claim 1, wherein the ion selective ion-specific membranes, are selected from the group consisting of: cation selective membranes and anion selective membranes.

6. The wastewater refinery of claim 1, wherein the valency-specific membranes are selected from the group consisting of: monovalent anion exchange membranes and monovalent cation exchange membranes.

7. (canceled)

8. The wastewater refinery of claim 1, wherein the at least one electrodialytic cell further comprises at least one bipolar membrane to control pH within at least one selected concentrate compartment so as to reduce precipitation of a specific ion being concentrated therein, thereby improving recovery of the specific ion from the wastewater.

9. (canceled)

10. The wastewater refinery of claim 1, further comprising a concentrate reservoir in fluid communication with at least one of the concentrate compartments.

11. The wastewater refinery of claim 1, wherein at least one of the concentrate compartments comprises an ion exchange resin.

12. The wastewater refinery of claim 11, wherein the ion exchange resin in the at least one concentrate compartment is different to the ion exchange resin in at least one other concentrate compartment.

13. A method of concentrating one or more components of wastewater, the method comprising:
introducing the wastewater into at least one electrodialytic cell;
providing a plurality of membranes and a plurality of concentrate compartments in the at least one electrodialytic cell, specific for the one or more components, each concentrate compartment being defined between an adjacent pair of membranes, and wherein the plurality of membranes comprise a combination of ion-specific or valency-specific or surface-modified ion-exchange membranes;
generating a current in the at least one electrodialytic cell such that the one or more components move through the membranes according to charge;
concentrating the one of more components in respective concentrate compartments; and
recovering the one or more components from the respective compartments.

14. The method of claim 13, wherein at least one of the concentrate compartments selectively retains and hence substantially removes a component from the concentrate.

15. The method of claim 14, wherein the at least one concentrate compartment effectively removes a single component from the wastewater.

16. The method of claim 14, wherein the at least one concentrate compartment is packed with ion exchange resin or ion capture resin and the component is recovered from the ion exchange resin or ion capture resin.

17. The method of claim 13, wherein at least one of the concentrate compartments includes a gas permeable membrane or a pervaporation membrane and the method further comprises recovering one or more components by pervaporation.

18. The method of claim 13, further comprises recovering one or more components by precipitation.

19. The method of claim 13, wherein the step of generating a current in the cell is by applying a potential across the electrodialytic cell of between 0.1 volts and 3 volts per compartment.
